(19) United States
(12) Patent Application Publication
(10) Pub. No.: US 2004/0111267 A1
(43) Pub. Date: Jun. 10, 2004

(54) Voice based placement system and method

(76) Inventors: Reena Jadhav, Redwood City, CA (US); Udhe Bir Singh Ahluwalia, Danville, CA (US)

Correspondence Address: Robert A. Parsons, PARSONS & GOLTRY, Suite 260, 340 East Palm Lane, Phoenix, AZ, 85004, US

(21) Appl. No.: 10/310,489

(22) Filed: Dec. 5, 2002

(51) Int. Cl. G10L 11/00

(52) U.S. Cl. 704/270

(57) ABSTRACT

A voice based placement system including a candidate call line, a voice recognition resume module coupled to the candidate call line for generating resumes from information received over the candidate call line, and a resume data base for receiving and storing the resumes. The system also includes a contractor call line, a voice recognition posting module coupled to the contractor call line for generating queries or postings from criteria received over the contractor call line, and a data base coupled to the posting module for receiving and storing the queries or postings. A comparator compares the queries or postings to the resumes to select matching candidate of the matching resume. Apparatus notifies the matching candidate.

This invention relates to placement systems.

More particularly, the present invention relates to voice based placement systems.

In a further and more specific aspect, the instant invention concerns matching data submitted by candidates and contractors.

### BACKGROUND OF THE INVENTION

Finding or filling vacant positions can be difficult for both contractors and candidates. In order for a candidate to find and be accepted to fill a position, candidates must search through various sources such as newspaper classifieds, local placement agencies, radio ads, career journals, walk-ins to local employers etc. etc. Once a position is located, a candidate must then contact and convince the contractor to let them fill the position. The acceptance process is generally initiated by the candidate submitting a generic paper application and waiting for a call back. If they receive further contact, they maybe pre-screened on the telephone, one or more interviews in person with managers and HR are typically required. At some point in the process, the contractor will accept or reject the candidate. This process can take a substantial amount of time and effort by the candidate. Frustration and failure are often the result, through no fault of their own.

This process is no less time consuming for the contractor, which must prepare a position description and find likely places to post it. Often multiple postings are necessary. The contractor must then wait for responses from candidates, then proceed with a selection process. Receiving paper applications, resumes by mail or even E-mail can be time consuming. Even more of a problem is reviewing all of the information to locate those candidates that appear acceptable. Many resumes received by contractors indicate unacceptable candidates. There is no way to differentiate between acceptable and unacceptable resumes without actually reading them. This can be costly, as well as time consuming. Errors often result, thereby potentially eliminating likely candidates. While this is a time-honored practice for filling positions, and can be adequately employed for eventually filling a position, it can be expensive to post positions in various locations. Sorting through the data or resumes received is also expensive and very time consuming. Furthermore, the process is unusable for a position that must be filled immediately or at least in a very short period of time. Basically, the manual process of hiring workers today is costly, time consuming and does not consistently lead to high quality hires.

It would be highly advantageous, therefore, to remedy the foregoing and other deficiencies inherent in the prior art.

Accordingly, it is an object of the present invention to provide a new and improved placement system.

Another object of the invention is to provide a voice based placement system.

And another object of the invention is to provide a voice based placement system, which increases the efficiency and reduces the cost of placement.

Still another object of the present invention is to provide a voice based placement system, which permits same day placement.

Another objective of the present invention is to deploy it in suppliers of candidates, such as wireless carriers who have real-time access to qualified candidates.

### SUMMARY OF THE INVENTION

Briefly, to achieve the desired objects of the instant invention in accordance with a preferred embodiment thereof, provided is a voice based placement system including a candidate portion for facilitating finding and obtaining a position, and a contractor portion for facilitating posting and filling a position.

The candidate portion includes a candidate call line for receiving calls from a plurality of candidates and a voice recognition resume module coupled to the candidate call line for generating a plurality of resumes. One resume is generated for each of the plurality of candidates from information received over the candidate call line. A resume database is coupled to the voice recognition resume module for receiving and storing the plurality of resumes. A contractor call line is provided for receiving a call with criteria from a contractor. A voice recognition contractor query module is coupled to the contractor call line for generating a contractor query from the criteria. A comparator compares the contractor query with the plurality of resumes to select at least one matching candidate with a resume that matches the contractor query. Apparatus is provided for notifying the at least one matching candidate.

The contractor portion includes a contractor call line for receiving calls from at least one contractor and a voice recognition posting module coupled to the contractor call line for generating a plurality of postings from the at least one contractor from information received over the contractor call line. A database is coupled to the voice recognition posting module for receiving and storing the plurality of postings. A candidate call line is provided for receiving a call with criteria from a candidate. A voice recognition query module is coupled to the candidate call line for generating a query from the criteria. A comparator is provided for comparing the query to the plurality of postings to select at least one matching posting. A voice recognition selection module is coupled to the candidate call line for receiving a positive response to the at least one matching posting and apparatus is provided for notifying the contractor of the positive response.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified flow diagram of a traditional placement process;

FIG. 2 is a simplified flow diagram of a placement system according to the present invention;

FIG. 3 is a simplified block diagram of a candidate portion of the voice based placement system of FIG. 2;

FIG. 4 is a more detailed block diagram illustrating the candidate portion of the voice based placement system of FIG. 3;

FIG. 5 is a flow chart illustrating the operation of the candidate portion of FIG. 4;

FIG. 6 is a simplified block diagram of a contractor portion of the voice based placement system of FIG. 1;

FIG. 7 is a flow diagram illustrating the contractor portion of the voice based placement system of FIG. 6; and

FIG. 8 is a simplified diagram illustrating a wireless embodiment of the voice based placement system.

### DETAILED DESCRIPTION OF THE PREFERRED EMBODIMENT

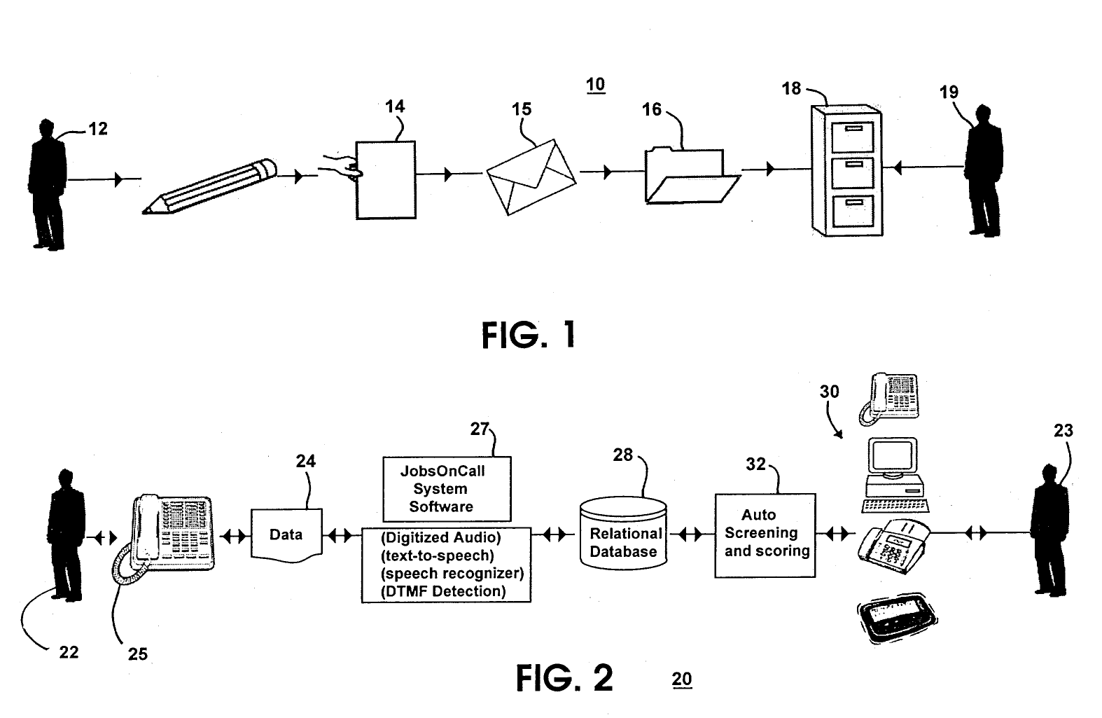

Turning now to the drawings, attention is first directed to FIG. 1, which illustrates a traditional placement process 10. In traditional process 10, a job seeker 12 manually prepares application/resume 14. Job seeker 12 must then locate a promising job/employer, using classified ads, in house postings, word of mouth, etc. Once a job/employer is located, application/resume 14 is sent 15, generally by mail, to the proper location. Upon receipt of application/resume 14, it is sorted, filtered, and otherwise handled 16 and manually stored 18 to make it available for review by the proper hiring manager 19. Manager 19 must then select the most likely seeming job seekers, and possibly continue the process with one or more personal interviews. This process is time consuming, and costly for both the job seeker and the employer.

Turning now to FIG. 2, a voice based placement system according to the present invention, generally designated 20, is illustrated. A candidate 22 is matched to a contractor 23, such as an employer, hiring manager, etc., by system 20 through the following general elements and steps. Candidate 22 submits relevant data 24 through a phone 25, facilitated by system software 27. System software 27 includes a telephony platform that can be, for example, Voice XML-based. System software 27 is employed to extract data from candidate 22 using various methods or combinations thereof, such as digitized audio, text-to-speech, speech recognition, DTMF detection, etc. Data 24 is stored in relational database 28 for immediate or future use along with data from other candidates using system 20. Contractor 23 can access relational database 28 through a device 30, such as by phone, web browser, fax, pager, etc. To access the desired data 24, a screening process 32 utilizes data from contractor 23 to match data 24, possibly along with other candidate data from relational database 28. In this example, data 24 from candidate 22 is the closest match. Other matches or close matches may also be provided, in which case additional selection procedures may be needed. As will be seen in the subsequent description, multiple matching criteria can be weighted to provide a priority order listing. Additionally, system 20 is sufficiently flexible to allow candidate 22 to input and change his data/resume and to permit contractor 23 to likewise post positions and change postings or information and criteria therefore. System 20 includes essentially two overlapping portions which will each be described, but which often utilize the same components. The portions include system 20 from the candidate side and a portion from the contractor side as will become apparent. This is the general system and more specific applications and apparatus will be described presently.

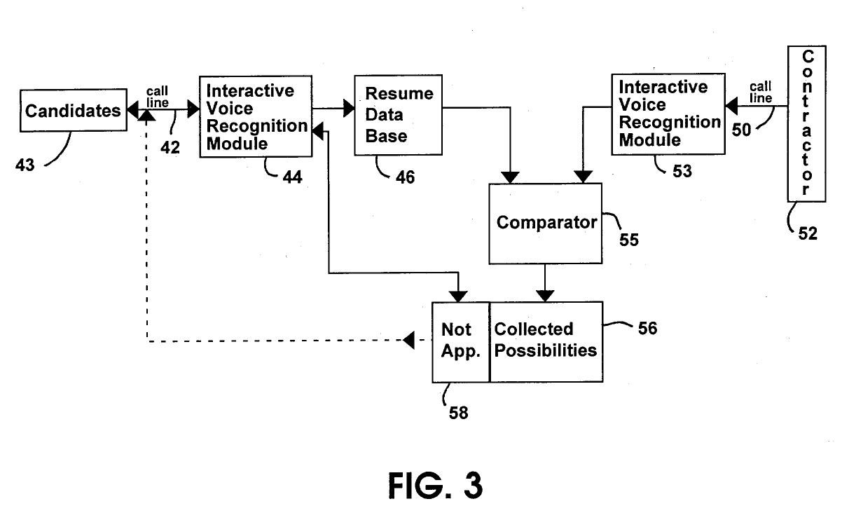

Referring now to FIG. 3, a functional portion of voice based placement system 20, generally designated candidate portion 40, is included to illustrate candidate apparatus and function in more detail. Candidate portion 40 includes a candidate call line 42 for receiving calls from a plurality of candidates 43. It should be understood that while one call line is illustrated and described, multiple call lines may also be employed. A voice recognition resume module 44, a part of system software 27 of FIG. 2, is coupled to candidate call line 42 for generating a plurality of resumes, one resume for each of the plurality of candidates from information received over candidate call line 42. A resume database 46 is coupled to interactive voice recognition resume module 44 for receiving and storing the plurality of resumes. Database 46 is preferably a part of relational database 28.

A contractor call line 50 receives a call with criteria from a contractor 52. The criteria can be a position posting for future candidates, as will be described presently, or an immediate request for a list of closely matching candidates already having resumes in the system. An interactive voice recognition contractor query module 53 is coupled to contractor call line 50 for facilitating the collection of and generating a contractor query from the criteria. A comparator 55 is coupled between voice recognition contractor query module 53 and resume database 46 for comparing the contractor query to the plurality of resumes. Comparator 55 is employed to select at least one matching or closely matching candidate with a resume that matches the contractor query. The one or more collected matching candidate resumes are stored in a filtered database 56.

The data in filtered database 56 can be used in a number of ways. For example, contractor 52 can receive the data either for selection or a continuation of the selection process, as for example by continuing with requests for additional data, interviews, etc., as will be described presently. Alternatively, the closest matching candidate can be notified. For example, if a temporary substitute employee is required immediately, resume data can include location and availability times that can be queried. System 40 then includes notification apparatus 58 which is preferably a phone, but can include pager, Internet, etc., which contacts the closest matching candidate.

Acknowledgement from the closest matching candidate is determined by a voice recognition acknowledgment module, which may be a portion of voice recognition resume module 44. The voice recognition acknowledgment module receives the acknowledgement and determines whether the candidate has given a positive or negative response. The acknowledgement can include a simple yes/no response, touch tone, or other indication. The candidate can also be verified by user ID and password or voice authentication. If a negative response is received, or if the candidate could not be contacted, the next closest candidate in filtered database 56 can be contacted. Once a positive response is received, the position can be immediately filled. It will be understood that the process described is preferably automated, providing real time manipulation of data.

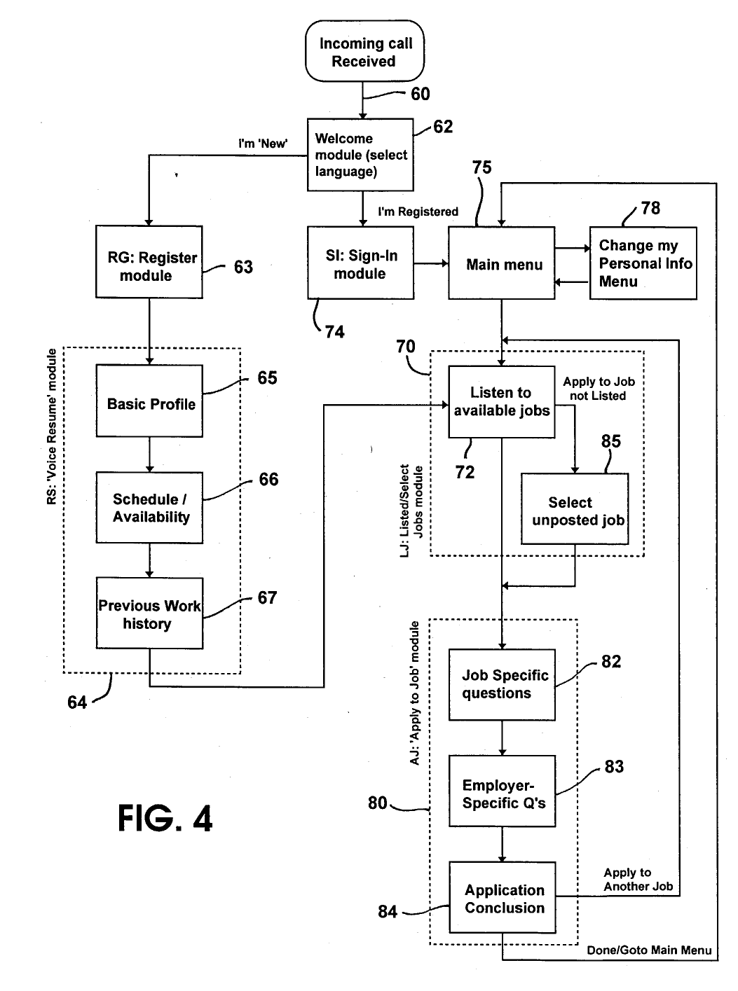

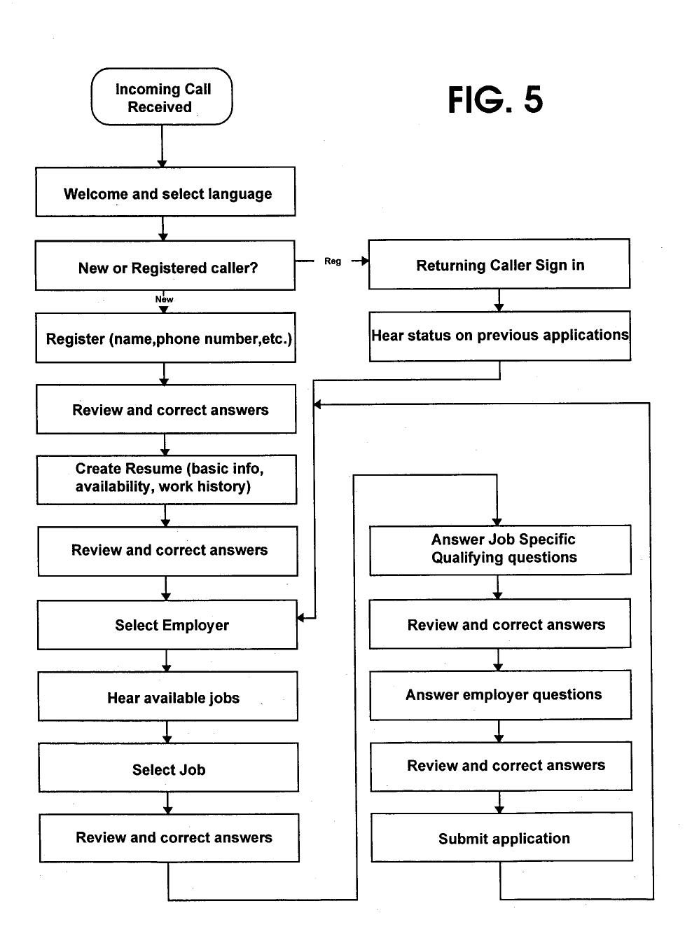

A more detailed embodiment of candidate portion 40 of system 20, specifying an example of locating and applying for a less time-dependent position, is illustrated in FIG. 4. It should be understood that many of the elements illustrated in FIG. 4 are included in the blocks of FIG. 3, but specific elements are not coordinated as they can vary in complexity and function, thus new reference numerals are used throughout. The operation of candidate portion 40 can also be seen with additional reference to FIG. 5. Incoming calls from candidates are received on incoming candidate call line 60. A welcome module 62 initiates the receipt of data by determining the language of the candidate, which will be used in the subsequent process. Welcome module 62 determines if the candidate is new or already registered, preferably by a simple query of the candidate. If new, the candidate is directed to a register module 63 where basic information such as name, phone number, etc. is collected, and after registration, to a voice recognition resume module 64. Registration can include a user ID and password or voice authentication for verification. Here it should be noted that many of the various modules, including modules 63 and 64, are connected to the relational database (database 28 in FIG. 2), the connections not being shown in FIG. 4 for simplicity. Resume module 64 uses a telephony platform that can be, for example, Voice XML-based. Extraction of data from a candidate is facilitated using various methods or combinations thereof, such as digitized audio, text-to-speech, speech recognition, DTMF detection, etc. A basic profile 65, schedule/availability 66, and previous work history 67 are preferably collected to form a resume for current or future use. Much of this information is stored as digital information, but some may be stored as voice recording such as wave files if desired.

As a specific example of the operation of the embodiment of resume module 64 illustrated in FIG. 4, once the candidate is registered, any combination or sequence of the following procedures are used for submitting the candidate's resume by phone. The resume and/or registration includes the candidate's name, pronounced as well as spelled e.g. John Smith, JOHN SMITH, work history for current and previous employers, recorded as spoken by the candidate, contact and availability information captured directly into the database, and any additional questions that help create a resume for the candidate. The recorded name is transcribed into words manually and the name text is stored in the resume database (database 46 in FIG. 3). The recorded work history is transcribed into words manually and work history text is stored in the database. The candidate's desired driving distance to a position is obtained and used to determine which companies will be read out to the candidate. The best time to call is included in the resume and used to determine what time to call the candidate back with any message or notification. The resume, entered by a candidate by phone, can be accessed by contractors via a web or phone interface. The candidate resume is preferably created by asking several questions to which responses can be: yes/no; input of numbers; and/or Verbal open speech. Resume questions can be classified into quality, capability, and fit.

Once registered, the candidate can then access a posting module 70 where the candidate can listen to available postings 72 or interactively select various types, categories, or even specific postings. In the event a candidate has previously registered, the candidate will be directed to a sign-in module 74 by welcome module 62. After sign-in, as directed by a main menu 75, the candidate can modify his resume 78 and/or proceed directly to posting module 70.

Once directed to posting module 70, and the candidate has selected a posting from available postings 72, a position module 80 facilitates the elicitation of additional information such as position specific data 82 and contractor specific data 83. Once sufficient data has been obtained, the process is concluded 84 with the candidate selecting a choice of returning to main menu 75, or returning to posting module 70 for selection of additional and/or alternate postings.

Once directed to posting module 70, the candidate can also desire a position not in available postings 72. In this instance, the candidate resume can be stored 85 as an available candidate for future postings.

As an example of the operation of the embodiment of candidate portion 40 illustrated in FIG. 4, with respect to a registered candidate directed to posting module 70, the candidate can select a posting through any one or combination of a variety of procedures. The procedures can include the candidate being read out the names of companies in the system, the candidate saying the position title of the position he is looking for, the candidate saying the name of the company he wants to work for, the candidate saying or entering a position code of a position that he read or heard through advertising by the contractor, the candidate saying or entering a company code that he read or heard through advertising by the contractor, the candidate being read out the list of companies within his desired driving distance and selecting the company he wants to apply to, the candidate being read out titles of positions that are open for a selected company, and/or the candidate being read out positions that the selected company has available, even though the company is not actively hiring for these positions.

Once the candidate selects the position he wants to apply for, he is read out more details of the position selected and asked if he wants to apply for the position. The candidate is then asked questions that the selected company has specified for that position. The candidate can also be asked questions that the company wants asked of all the candidates for all the positions. The candidate's questions are stored in the database and answers are processed in accordance with the criteria specified by the company for selecting candidates to be called for interview. When the candidate qualifies for being called for an interview, he is scheduled for the interview while online or can be called back with an automated interview scheduling call, Submissions by candidates over the phone can be accessed by contractors via a web or phone interface.

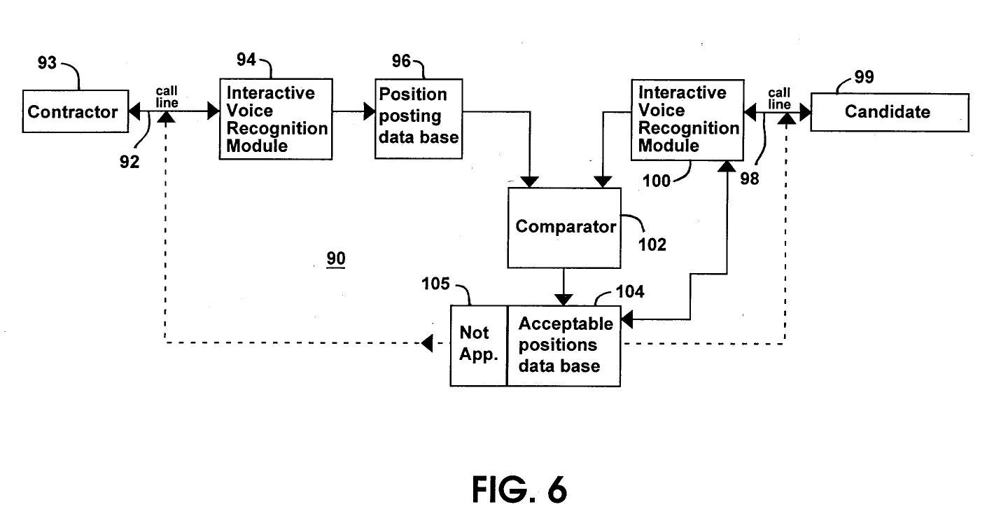

Referring now to FIG. 6, a functional portion of voice based placement system 20, generally designated contractor portion 90, is included to illustrate contractor apparatus and function in more detail. Contractor portion 90 includes a contractor call line 92 for receiving calls from at least one contractor 93. An interactive voice recognition posting module 94 is coupled to contractor call line 92 for generating a plurality of postings from contractor 93 from information received over contractor call line 92. A posting database 96 is coupled to voice recognition posting module 94 for receiving and storing the plurality of postings. A candidate call line 98 receives a call with criteria from a candidate 99. An interactive voice recognition query module 100 is coupled to candidate call line 98 for generating a query from the criteria. A comparator 102 is coupled between posting database 96 and voice recognition query module 100 for comparing the query to the plurality of postings to select at least one matching posting and storing the matching postings in an acceptable positions database 104. A voice recognition selection module, preferably incorporated in voice recognition query module 100 and which can include posting module 70 (FIG. 4), is coupled to candidate call line 98 for receiving a positive response from candidate 99 to the at least one matching posting, indicating candidate 99 is interested.

Contractors can Specify and change or update matching criteria, which determines the closeness of match between the candidates resume and position posting, for their own purposes. Matching criteria generally includes one or more of the following: answers to position specific questions; answers to company specific questions; availability for full-or part time work; availability for being called at short notice; availability for various shifts, i.e. available for night shifts; availability for days of the week, i.e. available for week ends and holidays; desired wage or whether flexible on wage; minimum education level required by contractor; and any special requirements. Relative weighting may be assigned to any of the matching criteria to establish relative importance. The matching criteria, including relative weighting, if any, is automatically applied to each candidate to determine the match results in real time, and indicate closeness of the match. The match results are stored in acceptable positions database 104, which in this embodiment is included as a portion of relational database 28 (FIG. 2). Contractors can specify a threshold of match results so that any candidate meeting the threshold or exceeding it is automatically scheduled for in-person interview. Candidates who meet or exceed the threshold are automatically scheduled for interview while they are online

Notifying apparatus 105 is coupled to the contractor call line 92 for notifying the contractor 93 of the positive response to a specific posting. At this point it should be noted that candidate 99 can be immediately hired for time sensitive positions such as temporary or substitute positions. However, additional information can be obtained prior to notification of the contractor, as detailed in FIG. 4, position module 80. It should further be noted that elements illustrated in FIG. 6 are simplified and various connections or blocks can include additional components that expand or augment the features of the system, some of which are described in greater detail with reference to FIG. 4 and others of which will be described presently.

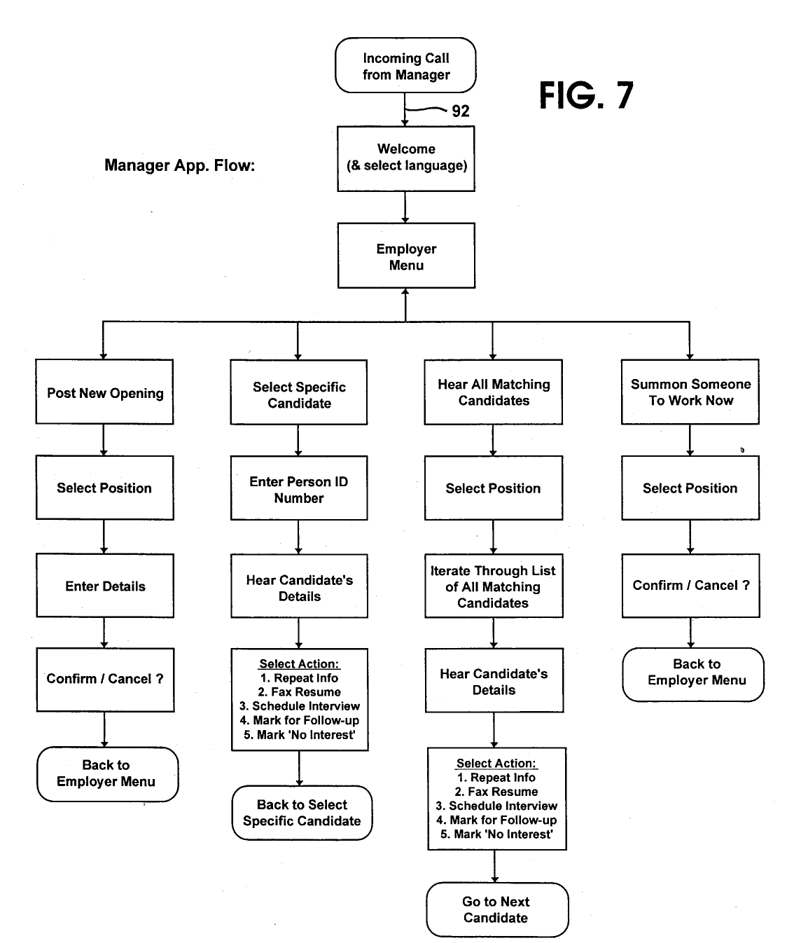

Referring now to FIG. 7, with continued reference to FIG. 6, a flow chart illustrates in more detail possible processes, which can be followed by a specific contractor. It should be understood that many of the steps illustrated in FIG. 7 are included in the blocks of FIG. 6, and some correlation will be provided. An incoming call from the contractor is received on incoming contractor call line 92. A welcome module, generally incorporated in module 94, initiates the receipt of data by determining the language of the contractor, which will be used in the subsequent process. If multiple contractors are utilizing the system, the welcome module may also inquire if the contractor is new or already registered. If new, the contractor can be directed to a register module where basic information is collected. If registered, the contractor is then directed to a contractor menu, providing the many options for using system 20.

The contractor can create a new posting, as described previously, by selecting a position, entering details of the position, and confirming or canceling the new posting. After entering a posting, the contractor is returned to the contractor menu. Another option is to select a specific candidate by entering the candidates identification number. The contractor can then review the candidate's resume and selects a specific action. The actions include: repeating the information; requesting a faxed resume; scheduling an interview; and marking for follow-up or indicating no interest. Again the contractor is returned to the contractor menu. An additional option is to review all matching candidates for a posting by selecting the posting and iterating though the list of all matching candidates. Further details of each likely candidate can then be reviewed and a specific action selected. The specific actions include: repeating the information; requesting a faxed resume; scheduling an interview; and marking for follow-up or indicating no interest. And again the contractor is returned to the contractor menu. A further option is to summon someone for immediately filling a position by selecting a posting and confirming or canceling the selection. The system then enters the process as described previously for time sensitive positions.

Some specific examples for performing the various contractor options are listed below. Contractors can: post a position opening by web or by phone; view on web or listen to on the phone, lists of pre-qualified candidates; view or listen to list of candidates scheduled for interview; view detailed resume and applications entered via the phone using a web interface; visually see candidates ranked as per the closeness of the match; view all applications submitted to the company for all positions in a single view; see, in a single view, all positions for which a candidate has been scheduled an interview; search for applications submitted by phone using a web interface and using search criteria that uses any one or combination of position or application details; listen to the voice of the candidate, such as playing back the recorded voice of the candidate saying his name and employment history; ask for a list of pre-qualified candidates scheduled for interview to be faxed to them; and/or ask for the resume and application of a candidate to be faxed to them. The list of candidates scheduled for interview is automatically faxed to the contractor. The list of all applications received on a day is automatically faxed to the contractor.

An automated interview scheduling process can also be incorporated into the system, a specific example of which is described below. Contractors can designate and update days of the week and time slots for in person interviews using the web or phone. The system schedules pre-qualified candidates for an interview online while they are on the phone applying for the position, using available time slots. Contractors can also select a candidate to be called for interview using the web or phone. Candidates selected for an interview are called by the systems automated outbound calling apparatus (e.g. notification apparatus 58), which calls the candidate at the time specified by the candidate as the best time to call. The system's automated apparatus detects whether it reached a live person or answering machine. If a live person is reached, he/she is authenticated using either a user identification plus password combination or voice authentication techniques. The candidate is scheduled for interview if he/she picks up the phone. If an answering machine is reached, a voice mail is left for the candidate to call back. When the candidate calls back next time, he is scheduled for an interview.

To further clarify the organization of this description, candidate portion 40 in generally illustrating the candidate inserts data (resume) into the system. The contractor can then query the system to find matching candidates. In the contractor portion 90, the contractor inserts data (posting) into the system. The candidate can then query the system to find matching postings. It will be understood by those skilled in the art that these portions are not separate, they are described independently for easy of understanding but form single system 20. For example, FIG. 3 includes interactive voice recognition resume module 44 for creating a resume for the candidate. FIG. 6 includes an interactive voice recognition query module 100, which facilitates creation of a query allowing the candidate to find and match postings. One skilled in the art will recognize that modules 44 and 100 can be the same module and preferably are, as the query and the resume may be substantially identical. Similarly, interactive voice recognition contractor query module 53 and interactive voice recognition posting module 94 can be the same module and preferably are, as the query and the posting may be substantially identical. Additionally, while we describe different comparators 55 and 102, they can be and preferably are a single comparator.

The voice based placement service provided by system 20 can be offered to contractors as a hosted service in which a dedicated company provides a central platform consisting of all telephony components, hardware and software that is shared by a plurality of contractors. However, in this case, the service can be fully customized for each contractor. The service would preferably be accessible through a common toll free number used by candidates applying for a position to any contractor. Contractors may also access the service via a common toll free number or a common web site. The service can also be provided as a private label service to contractors who want to operate an exclusive service for their company or group of companies or brand. Each contractor or brand provides their own phone number for accessing the service.

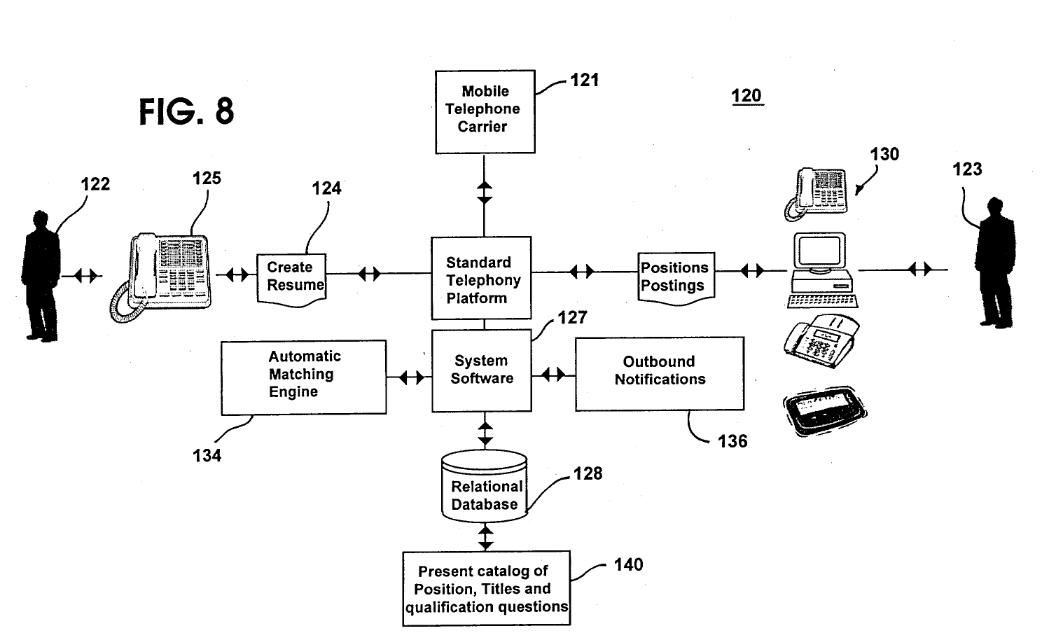

The voice based placement service provided by system 20 can also be offered to contractors and subscribers of wireless services. Referring to FIG. 8, a voice based placement system 120, according to the present invention, is illustrated as specifically applied to a wireless network. A candidate 122, such as a cellular telephone subscriber, is matched to a contractor 123 by system 120 through the following general elements and steps. Candidate 122 creates a resume 124 through a phone 125, facilitated by system software 127, which includes a telephony platform that can be, for example, Voice XML-based. System software 127 is employed to extract data from candidate 122 using various methods or combinations thereof, such as digitized audio, text-to-speech, speech recognition, DTMF detection, etc. Resume 124 is stored in relational database 128 for immediate or future use along with data from other candidates using system 120. Contractor 123 can access relational database 128 through a device 130, such as by phone, web browser, fax, pager, etc. To access the desired resume 124, a position posting/query and screening process 132 utilizes data/criteria from contractor 123 to match resume 124, possibly along with other candidate resumes from relational database 128. In this example, resume 124 from candidate 122 is the closest match. Other matches or close matches may also be provided, in which case additional selection procedures may be needed. As can be seen in the previous descriptions, multiple matching criteria can be weighted to provide a priority order listing. Additionally, system 120 is sufficiently flexible to allow candidate 122 to input and change his resume and to permit contractor 123 to likewise post positions and change postings or information and criteria therefore.

In this specific embodiment, system 120 is maintained and operated by a mobile telephone carrier 121 or other wireless provider. Thus the subscribers to the wireless service can elect to be candidates at subscription. In this case, cellular phone subscribers are able to create (box 124) a “Voice Resume” when they register for the cellular service. This resume is then continuously matched with open position postings 134 on the cellular network. Matching positions are alerted back to the candidate 122 by outbound notification 136, such as via interactive sms alerts, voicemail on their cell phone, and outbound calls on the cell phone. Database 128 can also include a present catalog of position titles and qualification questions 140.

Other specific features can be added to the voice based placement system as desired. For example, work opportunity tax credit (WOTC) identification and processing can be provided. The federal government enables employers who hire certain category of people to receive significant tax credits. The system can identify candidates who qualify for WOTC by asking a series of questions and then processing the answers to determine eligibility. Candidates who qualify for WOTC are marked as such in the database and are identified as such when a manager reviews list of candidates on the web or phone. When a WOTC qualified candidate is hired, the candidate information is automatically transmitted to a WOTC processing partner.

Another specific feature is a scheduling system. Companies can use the web to specify all their employees and workers, their job titles, seniority, and availability. Workers can call in to the system using a telephone and communicate whether they are available or not. If they are currently available, then they are available for automated scheduling for work within a certain time period. Employers can determine a master schedule for when a worker should be available or not. The employer can call and request resources. The system matches resource requests to available labor resources, matching availability status and other criteria, and commences making outbound calls to alert workers that they are needed. This communication may be in the form of sms interactive alert, voicemail to all contact phone numbers, or an interactive call to all matching available workers. Workers can then respond to the alert with an acceptance or a decline. That information is communicated back to the employer with total responses. The system tracks and builds profiles on workers with respect to number of acceptances and declines on requested work calls. The worker can call into the system and state whether they are available or not available. This is used by the system to then contact them when a work request comes in.

A further feature is a profiling and quality management function. The system offers a feature that can then be used to track star performers, poor performers and turnover candidates. The information collected from these workers is then compiled in the system to continuously improve the questions to be asked for pre-qualifying candidates.

Thus, provided is a new and improved placement system. The voice based placement system increases the efficiency and reduces the cost of placement and permits same day placement. In a preferred embodiment, the system uses speech recognition and database technology and is secured by a combination of user ID and password or voice authentication using voice recognition technology. The system is accessible by either web or phone or both and stores any one or more of the following information:

candidate resume;

position applications submitted by the candidate;

status on position applications submitted;

scheduled interviews for all positions; and

reminders for interview.

Candidates can do the following on the system:

view or listen to and edit resume;

view or listen to and edit position preferences and selection criteria for positions;

view or listen to or cancel applications submitted;

view or listen to status of applications for various positions;

view or listen to scheduled interviews;

accept or decline requests for interviews to be scheduled; and

have the resume submitted automatically to contractors who meet the candidate's criteria.

The system can provide a method that enables mass submission of a resume to qualifying contractors and that can enable mass notification of position postings to qualified candidates.

Various other features may be employed, such as leveraging location based technology to determine which candidates to contact. A profile created by candidates that generates a continuous job search robot that finds and communicates all matching jobs via sms alert, call to cell phone, voicemail on cell phone which is provisioned as a special section. Provisioning of a “hot key” on the carrier network that automatically drops a subscriber into the system without dialing the complete phone number.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A voice based placement system comprising:
a candidate call line for receiving calls from a plurality of candidates;
a voice recognition resume module coupled to the candidate call line for generating a plurality of resumes, one resume for each of the plurality of candidates from information received over the candidate call line;
a resume data base coupled to the voice recognition resume module for receiving and storing the plurality of resumes;
a contractor call line for receiving a call with criteria from a contractor;
a voice recognition contractor query module coupled to the contractor call line for generating a contractor query from the criteria;
a comparator for comparing the contractor query to the plurality of resumes to select at least one matching candidate with a resume that matches the contractor query; and
apparatus for notifying the at least one matching candidate.

2. A system as claimed in claim 1 wherein the apparatus for notifying includes acknowledgement apparatus for receiving a response from the at least one matching candidate.

3. A system as claimed in claim 2 wherein the apparatus for notifying includes a notification call line.

4. A system as claimed in claim 3 wherein the acknowledgement apparatus includes a voice recognition acknowledgment module for receiving the acknowledgement and determining a positive response.

5. A system as claimed in claim 2 further including a memory coupled to the comparator for storing a list of matching candidates, and the apparatus for sequentially notifying matching candidates on the list.

6. A system as claimed in claim 5 wherein the acknowledgement apparatus includes a voice recognition acknowledgment module for receiving the acknowledgement, determining a positive response, and terminating sequential notification upon reception of a positive response.

7. A system as claimed in claim 1 further comprising:
the contractor call line for receiving a call with posting information from the contractor;
a voice recognition posting module coupled to the contractor call line for generating a posting from the posting information received over the contractor call line;
a posting data base coupled to the voice recognition posting module for receiving and storing a plurality of postings;
the candidate call line for receiving a call with criteria from a candidate of the plurality of candidates;
a voice recognition candidate query module coupled to the candidate call line for generating a candidate query from the criteria;
a comparator for comparing the candidate query to the plurality of postings to select at least one matching posting;
a voice recognition posting selection module coupled to the candidate call line for receiving a positive response to the at least one matching posting; and
apparatus for notifying the contractor of the positive response.

8. A system as claimed in claim 7 wherein the apparatus for notifying the contractor includes apparatus for accessing the resume data base and forwarding the resume of the candidate to the contractor.

9. A voice based placement system comprising:
a contractor call line for receiving calls from at least one contractor;
a voice recognition posting module coupled to the contractor call line for generating a plurality of postings from the at least one contractor from information received over the contractor call line;
a data base coupled to the voice recognition posting module for receiving and storing the plurality of postings;
a candidate call line for receiving a call with criteria from a candidate;
a voice recognition query module coupled to the candidate call line for generating a query from the criteria;
a comparator for comparing the query to the plurality of postings to select at least one matching posting;
a voice recognition selection module coupled to the candidate call line for receiving a positive response to the at least one matching posting; and
apparatus for notifying the contractor of the positive response.

10. A system as claimed in claim 9 wherein the voice recognition query module includes a voice recognition resume module for generating a resume for the candidate from information received over the candidate call line.

11. A system as claimed in claim 10 further including a resume data base for storing the resume.

12. A voice based placement method comprising the steps of:
receiving calls from a plurality of candidates;
generating a plurality of resumes, one resume for each of the plurality of candidates from information received, using a voice recognition resume module;
storing the plurality of resumes in a resume data base;
receiving a call with criteria from a contractor and generating a contractor query from the criteria, using a voice recognition contractor query module;
comparing the contractor query to the plurality of resumes to select at least one matching candidate with a resume that matches the contractor query; and
notifying the at least one matching candidate.

13. A method as claimed in claim 12 further including receiving an acknowledgement from the at least one matching candidate and determining a positive response.

14. A method as claimed in claim 13 further including storing a list of matching candidates, and sequentially notifying matching candidates on the list.

15. A method as claimed in claim 14 further including the step of terminating sequential notification upon reception of a positive response.

16. A method as claimed in claim 12 wherein the step of generating a plurality of resumes from information received includes at least one of asking several questions to which responses are yes/no, input of numbers, and verbal open speech.

17. A voice based placement method comprising:
receiving a call from at least one contractor and generating a plurality of postings from the at least one contractor from information received, using a voice recognition posting module;
storing the plurality of postings;
receiving a call with criteria from a candidate and generating a query from the criteria using a voice recognition query module;
comparing the query to the plurality of postings to select at least one matching posting;
receiving a positive response to the at least one matching posting using a voice recognition selection module; and
notifying the contractor of the positive response.

18. A wireless communication network including a voice based placement system comprising:
a wireless communication network;
a plurality of candidate wireless communication devices subscribed to the network;
a candidate call line for receiving calls from the plurality of candidate wireless communication devices;
a voice recognition resume module coupled to the candidate call line for generating a plurality of resumes, one resume for each of the plurality of candidates from information received over the candidate call line;
a resume data base coupled to the voice recognition resume module for receiving and storing the plurality of resumes;
a contractor call line for receiving a call with criteria from a contractor;
a voice recognition contractor query module coupled to the contractor call line for generating a contractor query from the criteria;
a comparator for comparing the contractor query to the plurality of resumes to select at least one matching candidate with a resume that matches the contractor query; and
apparatus for calling the subscribed wireless communication device of the at least one matching candidate.

19. A placement system comprising:
a candidate call line;
a resume module coupled to the candidate call line for generating a plurality of resumes, one resume for each of a plurality of candidates from information received over the candidate call line;
a resume data base coupled to the resume module for receiving and storing the plurality of resumes;
a contractor call line;
a posting module coupled to the contractor call line for generating one of a plurality of queries and postings from at least one contractor from criteria received over the contractor call line;
a data base coupled to the posting module for receiving and storing the one of the plurality of queries and postings;
a comparator for comparing the one of the plurality of queries and postings to the plurality of resumes to select at least one matching candidate with a resume that matches the one of the plurality of queries and postings; and
apparatus for notifying the at least one matching candidate.

20. A placement system as claimed in claim 19 wherein the candidate call line is a subscribed line in a wireless system.
